(19) United States
(12) Patent Application Publication
(10) Pub. No.: US 2003/0049955 A1
(43) Pub. Date: Mar. 13, 2003

(54) Clip for replaceable surface mounted devices

(75) Inventor: Robert G. Schilling, Dolgeville, NY (US)

Correspondence Address: OSTROLENK FABER GERB & SOFFEN, 1180 AVENUE OF THE AMERICAS, NEW YORK, NY, 100368403

(73) Assignee: Bel-Fuse, Inc.

(21) Appl. No.: 10/241,787

(22) Filed: Sep. 10, 2002

Related U.S. Application Data
(60) Provisional application No. 60/322,052, filed on Sep. 13, 2001.
(60) Provisional application No. 60/381,834, filed on May 16, 2002.

(51) Int. Cl. H01R 12/00

(52) U.S. Cl. 439/83

(57) ABSTRACT

A clip for a surface mounted device, such as a fuse, which is attachable to a fuse by spring pressure and is attachable to a printed wiring board by soldering. The inner portions of the clip surfaces are non-solderable whereas the outer surfaces are covered with a solderable material. As a result, the inner surfaces of the clips and end caps of the fuse are not soldered during the soldering operation. This enables a fuse to be easily removed from the clips and replaced with a new fuse.

### CROSS REFERENCE TO RELATED APPLICATIONS

This application claims priority to application No. 60/322,052, filed Sep. 13, 2001 and entitled “FUSE CLIPS FOR ADDING FIELD REPLACEMENT TO SMT FUSES” and application No. 60/381,834, filed May 16, 2002 and entitled “FUSE CLIPS FOR ADDING FIELD REPLACEMENT TO SMT FUSES,” the entire disclosures of which are incorporated by reference herein.

### BACKGROUND OF THE INVENTION

This invention relates to surface mount technology and, in particular, to clips for enabling replacement of surface mounted devices, such as fuses.

Today's high density electronic devices are made possible by utilizing surface mount technology (SMT), where small, individual components are automatically placed on solder-paste charged pads of a printed circuit board and the resultant “loaded” board is then heated to affect a solder joint by solder reflow at each point of electrical contact. To assemble such boards at high automation speeds it is essential that the components being placed are both as small and as light as possible.

One type of component frequently involved in such assemblies is a fuse. One or more fuses are typically provided to add overcurrent protection and user safety to the device being produced. Small, lightweight fuses having good placement characteristics and planar terminals to engage the circuit board pads are available from several manufacturers. These fuses function well in the SMT assembly process but their means of attachment does not allow for expeditious field replacement should an easily correctable electrical fault occur while the device is in service.

Up to now, adding field replacement capability to such fuses necessitated either purchasing the fuse preloaded into a larger fuse holder prior to its placement on the circuit board or adding it to a mounted fuse holder “after the fact” by costly means, such as manual insertion. Fuse holders available for this purpose typically include two clips that engage the fuse's end terminals. These are set into a plastic base or housing having a geometry that effectively protects the fuse terminals and engagement clips against wetting during a reflow attachment to the board. The size and weight of such a holder both slows replacement time and consumes circuit board real estate, both undesirable consequences.

### SUMMARY OF THE INVENTION

It is an object of the present invention to provide a clip which will enable smaller, lighter and replaceable assembly of surface mounted devices, such as fuses, with the concomitant advantages of a smaller size, faster emplacement and replacement and lower unit costs.

These and other objects are accomplished by a clip for a surface mounted device, which includes a bottom wall, and first and second spaced side walls and a rear wall upstanding from the bottom wall. The spacing between the side walls is slightly less then the width of the device so that when the device is placed within the side walls, the side walls exert a force on the device. Surfaces of the bottom wall, side walls and rear wall which face away from the device have a solderable material thereon and surfaces which face the device are nonsolderable.

In accordance with certain aspects of the invention, the bottom wall, the side walls and the rear wall are each made of a conductive non-solderable metal, and detents are directed inwardly of the sidewalls to apply greater pressure to the device to maintain better electrical contact and to aid in clamping and retaining the device within the clip, the detents being provided on front edges of the sidewalls.

In accordance with other aspects, the bottom wall, side walls and rear wall are integral with one another, the clip is made of resilient material, the rear wall is curved inwardly and set backs are provided to prevent soldering of the device during soldering of the clip.

In accordance with another aspect, the clip is used to retain a fuse having end caps. In this instance the spacing between the curved surface of the rear wall and the detents is slightly less than the length of the end caps so that the rear wall exerts a spring force to force the end cap against the detents.

Preferably, the clip is used with a surface mounted fuse having end caps. For this use, two clips are provided. Each clip includes a bottom wall and first and second spaced side walls and a rear wall upstanding from the bottom wall, the spacing between the side walls is slightly less then the width of an end cap so that when an end cap is placed within the side walls the side walls exert a force on the end cap.

Advantageously, the bottom wall, the side walls and the rear wall of each clip are each made of a conductive non-solderable metal, the surfaces of the bottom wall, side walls and rear wall of each clip which face away from the end cap within the clip have a solderable material thereon and the surfaces which face the device are non-solderable. Set backs are provided to prevent soldering of the end caps during soldering of the clips. The clips may also be provided with detents to aid in locating the fuse within the clips and to provide increased electrical contact.

Other features and advantages of the present invention will become apparent from the following description of the invention which refers to the accompanying drawings.

### BRIEF DESCRIPTION OF THE DRAWINGS

FIG. 1 is an elevation view showing a pair of clip units comprising a clip in accordance with certain principals of the invention for retaining a device;

FIG. 2 is a plan view of the clip of FIG. 1;

FIG. 3 is an end view of the clip of FIG. 1; and

FIG. 4 is a metal stamping from which the fuse clip of FIGS. 1-3 may be formed.

### DETAILED DESCRIPTION OF THE PREFERRED EMBODIMENT(S)

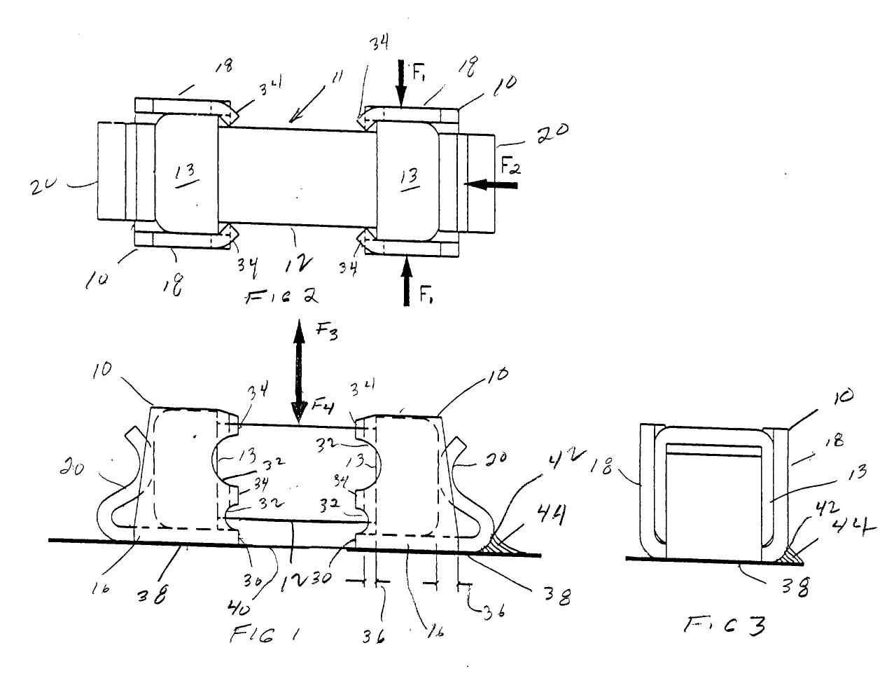

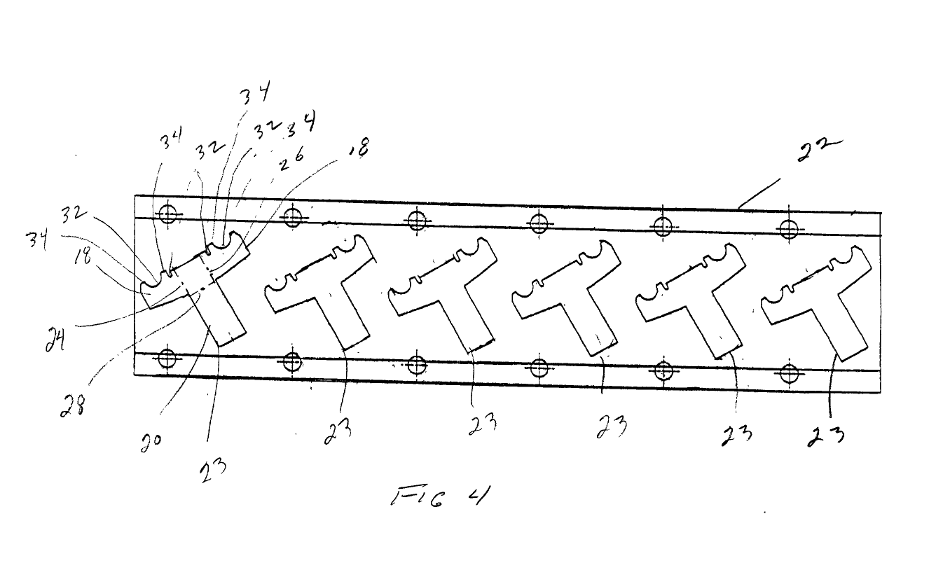

Referring to FIGS. 1-3, there is shown a pair of clips 10 for retaining a device, such as an SMT fuse 11, which includes a body 12 and end caps 13. The clips 10 are shown mounted on a printed wiring board. The clips 10 are spaced apart such that the fuse 11 may be snugly retained by the clips 10, as will be discussed in more detail below.

Each of the clips 10 includes a bottom wall 16, side walls 18 and a rear wall 20. Preferably, each of the rear walls 20 is curved inwardly.

Each of the bottom wall 16, the side walls 18 and the rear wall 20 are made of a conductive, corrosion resistant, resilient, solderable metal alloy, such as Inconel 625. Advantageously, as shown in FIG. 4, each clip can be made by a conventional stamping operation from a strip 22 having a plurality of stamping units 23 from which the clips are formed after stamping by bending along the bend lines 24, 26 and 28.

Prior to stamping, the face of the strip 22, which will become the outsides and bottom of the clip, is electroplated with a base layer of a metal, such as copper to promote adhesion and is then overplated with a suitable solderable alloy, such as tin. After the clips 10 are formed, this renders the bottom and outsides of the clips 10 solderable while preventing soldering of the inside surfaces. All peripheral edges of the clips 10 are sheared edges. Accordingly, these edges are also non-solderable. The edges 30 at the bottom thus act as further barriers to solder bridging to the end caps 13.

The lateral spacing of the sidewalls 18 is slightly less then the width of the fuse end caps 13 so that the fuse 11 may be snugly received between the side walls 18 and retained therein by lateral spring clamping forces which are represented by the arrows designated F₁ in FIG. 2.

The front edges of the side walls include cut-outs 32 which enable inwardly facing stops or detents 34 to be formed by bending the front edges on either side of the cut-outs 32. In the embodiment shown each clip has four detents 34, two on each sidewall 18. The detents 34 enhance electrical contact of the fuse clips 10 to the fuse caps 13. More specifically, these multiple points of contact counter the increase in electrical resistance between the clips 10 and the fuse caps 13 caused by the use of Inconel whose resistivity is higher than copper.

Additionally, the detents 34 coact with the rear wall 20 to provide for positive location of the clip 10 to the fuse cap 13. This is effected by the inward curvature of the rear wall 20 providing a longitudinal spring force F₂ which forces the front edge of the fuse cap 13 forward against the four detents 34 which define a vertical plane.

The detents 34 and the rear spring wall 20 act as pincers having a distance between them slightly less than the length of the cap 13, thereby capturing the cap 13 between them. This is done because the caps 13 have a very consistent length, unlike the fuses 11 themselves which can vary significantly from piece to piece.

The independent clamping action of each clip 10 allows it to locate the cap 13 squarely against the plane of the detents 34 and to be retained with sufficient force to survive normal handling and placement of the assembly on a circuit board 40. The clips 10 do not normally coact with one another. Coaction would only occur if the fuse 11 were changed for one with a slightly different length after mounting of the clips 10 to the circuit board 40 had taken place. In this situation the two soldered clips 10 have sufficient compliance between them to compensate for the change in fuse length while still supplying adequate contact and retention force. If the new fuse 11 were shorter, the side walls would open slightly as the detents 34 rode upon the cap edges somewhat. If the new fuse 11 were longer, the rear springs 20 would open axially and the cap edges would set back slightly from the detents 34. In both scenarios, increased force at the final points of contact would compensate for any loss of contact area due to the slight misalignment.

The geometry of the clips includes set backs 36 between the bottom edges of the fuse caps 13 and the forward and rear open edges of each clips 10. These set backs 36 further isolate the solderable fuse caps 13 from the mass of solder paste liquefied when the clips 10 are soldered to their printed circuit pads 38. Since all the internal surfaces of the clips are non-solderable, the solder plated surfaces of the fuse caps 13 do not adhere to the clips even when the circuit board 40 upon which the printed circuit pads 38 are located is exposed to reflow temperatures.

Large radii 42, at the base of the side walls 18 and rear walls 20 of the clip 10 allow for the formation of generous solder fillets 44 to firmly attach the clips 10 to their respective circuit board pads 38.

In use, the clips 10 may be soldered to a printed wiring board 40 prior to a fuse 11 being inserted therein or the fuses 11 may be first assembled with the clips 10 and then the assembly soldered to the wiring board 40 as a unit.

Since the clips 11 only cover the fuse caps 13, replacement is easily effected by lifting the fuse body 12 from beneath thereby applying an upward force F₃, as shown in FIG. 2. To insert a new fuse the process is reversed and a force F₄ is applied in the opposite direction to insert the fuse 11 in the clips 10. Covering only the end caps 13 with the clips 10 also allows for improved convection around the fuse body 12 to aid in reducing the temperature of the fuse.

Among the other advantages of the subject invention are:

1. The mass of the clips 10 is such that they provide additional thermal mass (i.e. transient heatsinking) to the fuse 11, allowing the fuse 11 to sustain slightly greater short term overloads before clearing.

2. The use of individual clips 10 rather than a conventional molded holder allows them to be used with fuses 11 of varying length that share the same size and cap 13.

3. The use of set back geometry, fabrication from non-solderable metal and solder's inherent high surface tension prevent molten solder from bridging to the solderable caps 13 of the fuse 11 during reflow attachment of the clips 10 to the circuit board 40. Detrimental intrusion of solder into the flexural area of the clip is similarly prevented. Thus, no surrounding plastic housing to serve as a solder mask at the expense of overall size is required.

4. The quality of the solder joints 44 attaching the clips 10 to the circuit board 40 are easily inspected. Conventional, molded plastic holders typically provide less solderable area. They also preclude visual inspection of much of the affixing joint.

Although the present invention has been described in relation to particular embodiments thereof, many other variations and modifications and other uses will become apparent to those skilled in the art. It is preferred, therefore, that the present invention be limited not by the specific disclosure herein, but only by the appended claims.

What is claimed is:

1. A clip for a surface mounted device, which comprises:
a bottom wall, and first and second spaced side walls and a rear wall upstanding from the bottom wall, the spacing between the side walls being slightly less then the width of the device so that when the device is placed within the side walls, the side walls exert a force on the device, wherein surfaces of the bottom wall, side walls and rear wall which face away from the device have a solderable material thereon and surfaces which face the device are nonsolderable.

2. The clip in accordance with of claim 1, wherein the bottom wall, the side walls and the rear wall are each made of a non-solderable conductive metal.

3. The clip in accordance with claim 2, wherein detents directed inwardly of the sidewalls are provided to apply greater pressure to the device to maintain better electrical contact and to clamp and locate the device within the clip.

4. The clip in accordance with claim 3, wherein the detents are provided on front edges of the sidewalls.

5. The clip in accordance with claim 4, wherein the bottom wall, side walls and rear wall are integral with one another.

6. The clip in accordance with claim 1, wherein the clip is made of a conductive resilient material.

7. The clip in accordance with claim 6, wherein the rear wall is curved inwardly so as to form a leaf spring.

8. A clip for a surface mounted fuse, having a body and an end cap, which clip comprises:
a bottom wall, and first and second spaced side walls upstanding from the bottom wall, the spacing between the side walls being slightly less then the width of an end cap so that when the end cap is placed within the side walls, the side walls exert a force on the device, wherein the surfaces of the bottom wall, side walls and rear wall which face away from the end cap have a solderable material thereon and the surfaces which face the end cap are non-solderable.

9. The clip in accordance with claim 8, wherein the bottom wall, the side walls and the rear wall are each made of a non-solderable conductive metal.

10. The clip in accordance with claim 9, wherein detents directed inwardly of the sidewalls are provided to apply greater pressure to the end cap to establish better electrical contact and to clamp and locate the fuse within the clip.

11. The clip in accordance with claim 10, wherein the detents are provided on front edges of the sidewalls.

12. The clip in accordance with claim 8, wherein set backs are provided between the bottom edges of the end cap and the forward and rear open edges of the sidewalls.

13. The clip in accordance with claim 12, wherein the bottom wall, side walls and rear wall unit are integral with one another.

14. The clip in accordance with claim 8, wherein the clip is made of resilient material.

15. The clip in accordance with claim 14, wherein the rear wall is curved inwardly to form a leaf spring.

16. A clip for mounting a surface mounted fuse having a body and opposing end caps, which clip comprises:
a bottom wall, and first and second spaced side walls and a rear wall upstanding from the bottom wall, the spacing between the side walls being slightly less then the width of an end cap so that when an end cap is placed within the side walls the side walls exert a force on the end cap; and
a plurality of detents provided on front edges of each sidewall and the rear wall being made of a resilient material and being curved inwardly, the spacing between the curved surface of the rear wall and the detents being slightly less then the length of a fuse end cap so that when the fuse end cap is inserted in the clip the curved rear wall exerts a spring force forcing the end cap against the detents.

17. The clip in accordance with claim 16, wherein the bottom wall, the side walls and the rear wall are each made of a non-solderable conductive metal.

18. The clip in accordance with claim 17, wherein the surfaces of the bottom wall, side walls and rear wall which face away from the end cap have a solderable material thereon and the surfaces which face the end cap are unsolderable.

19. The clip in accordance with claim 18, wherein the bottom wall, side walls and rear wall are integral with one another and wherein set backs are provided between the bottom edges of and end cap and the forward and rear open edges of the sidewalls.

20. An arrangement for mounting a surface mounted fuse having a body and opposing end caps, which clip comprises:
first and second clips, each clip comprising a bottom wall, and first and second spaced side walls and a rear wall upstanding from the bottom wall, the spacing between the side walls being slightly less then the width of an end cap so that when an end cap is placed within the side walls the side walls exert a force on the end cap;
wherein the bottom wall, the side walls and the rear wall of each clip are made of a non-solderable conductive metal; and the surfaces of the bottom wall, side walls and rear wall of each clip which face away from the end cap have a solderable material thereon and the surfaces which face the end cap are unsolderable.

21. The arrangement in accordance with claim 20, wherein the bottom wall, side walls and rear wall of each clip are integral with one another and wherein in each clip set backs are provided between the bottom edges of an end cap and the forward and rear open edges of the sidewalls of the clip.

22. The arrangement in accordance with claim 21, wherein detents are provided on the front edges of the sidewalls of each clip and each rear wall is made of a resilient material and is curved inwardly, the spacing between the curved surface of each of the rear walls of a clip and the detents thereof being slightly less than the length of a fuse end cap so that when a fuse end cap is inserted in the clip the curved rear wall exerts a spring force forcing the end cap against the detents.
